(19) United States
(12) Patent Application Publication
(10) Pub. No.: US 2005/0046200 A1
(43) Pub. Date: Mar. 3, 2005

(54) LATCH

(75) Inventor: Christer Gustav Dominique, Torslanda (SE)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: FORD GLOBAL TECHNOLOGIES, LLC, Dearborn, MI (US)

(21) Appl. No.: 10/604,941

(22) Filed: Aug. 28, 2003

(51) Int. Cl. E05C 3/06

(52) U.S. Cl. 292/216

(57) ABSTRACT

Latch device (1) of a lid to a compartment of a vehicle, preferably a device for preventing unintentional trunk entrapment. The device (1) includes a claw (3, 3a) being in engagement with a striker (4, 4a) when the lid is closed, or being held in a ready-to-engage state when the lid is open, in which state the claw (3, 3a) is ready to be positively brought into a locked position upon closing the lid. The inventive concept also includes an opening/unlocking sub device (11, 11a; 12, 12a) having elastic biasing means ( ) as well as a releasable pawl (16, 16a) for the capture and storage of potential energy. The sub device (11, 11a; 12, 12a) is connected to an arrangement (17) in the compartment of said vehicle for the release of said pawl (16, 16a), to thereby upon release of said claw (3, 3a), simultaneously and momentarily also release the energy stored in the opening/unlocking device (11, 11a; 12, 12a) against either said lid or part of the structure of the vehicle, to positively be able to force said lid to a visibly open position.

### BACKGROUND OF INVENTION

1. Technical Field

The present invention relates to a latch device of a lid to a compartment of a vehicle, preferably a mechanism for preventing unintentional trunk entrapment, comprising a claw being in engagement with a striker when the lid is closed, or being held in a ready-to-engage state when the lid is open, in which state the claw is ready to be positively brought into a locked position upon closing the lid.

2. State of the Art

Unfortunately there are still situations where for instance children get entrapped inside vehicle trunks. This may happen under the most innocent circumstances, for instance when children are playing hide and seek at a local scrap yard, since as we all know, to children the forbidden always is the most interesting and inviting, but also under more serious or dangerous circumstances where someone is put in a vehicle trunk against his or her own will and thus is entrapped. Vehicle trunks are traditionally quite enclosed sites. The available volume thereof is normally very limited, thus the possibilities to move therein are small. Therefore, the available amount of air is also limited. Consequently an entrapment of this kind represents a serious, deadly risk if disregarded. Today a direct pawl release is used having a fluorescent handle. The release effort thereof is with existing solutions definitely is too high for a child entrapped like this. On top of this, many times also the weight of the trunk lid is such that even if a person who is entrapped manages to release the direct pawl, he or she may not realize that the trunk lid has been released since it stays in the same position in spite of the release due to its weight and maybe also due to failing lifting means. The effort to open the trunk lid may be heightened under certain circumstances such as cases where snow has piled upon the outside of the lid.

### SUMMARY OF INVENTION

It is therefore an object with the present invention to minimize the release effort necessary to release a trunk lid of a vehicle from the inside thereof, should someone become entrapped inside such a trunk. The aim is to reduce the effort to a level on or around one fifth the level of existing solutions. This level represents an effort that more or less equals forces such as sealing forces and tolerances of the vehicle structure itself and cannot with foreseeable means be further minimized.

According to the present invention of the trunk lid latch device, the latch includes an opening/unlocking sub-device, having elastic biasing means as well as a releasable pawl for the capture and storage of potential energy, the sub device is connected to an arrangement in the compartment of the vehicle for the release of the pawl, to thereby upon release of the claw, simultaneously and momentarily also release the energy stored in the opening/unlocking device against either the lid or part of the structure of the vehicle, to positively force the lid to a visibly open position.

The opening/unlocking sub device includes a pop-up bar, part of which is encircled by a coil spring acting between a part of a trunk lid or a part of the structure of the vehicle and an abutment on the bar, the abutment acting both as such to the spring and as an abutment to the release pawl. This means that the spring automatically or by hand will become loaded again by making use of the pop-up bar when or before the trunk lid is closed after having been activated making use of the inventive device.

The device according to the invention includes a block bar which automatically blocks the sub device in an open position for the trunk lid. Hereby a slumbering device is achieved, which is possible to activate only should a person become entrapped inside a trunk.

Also by being completely mechanical, the sub device will provide an elimination of the risk for entrapment also in a car on a scrap yard, since no electricity is required for it to work.

### BRIEF DESCRIPTION OF DRAWINGS

Below the present invention will be described with reference to two schematic embodiments, shown on the enclosed drawings, in which

FIG. 1 show a schematic view of a first embodiment of a trunk lid latch device according to the invention, and

FIG. 2 shows another schematic view of a second embodiment thereof.

### DETAILED DESCRIPTION

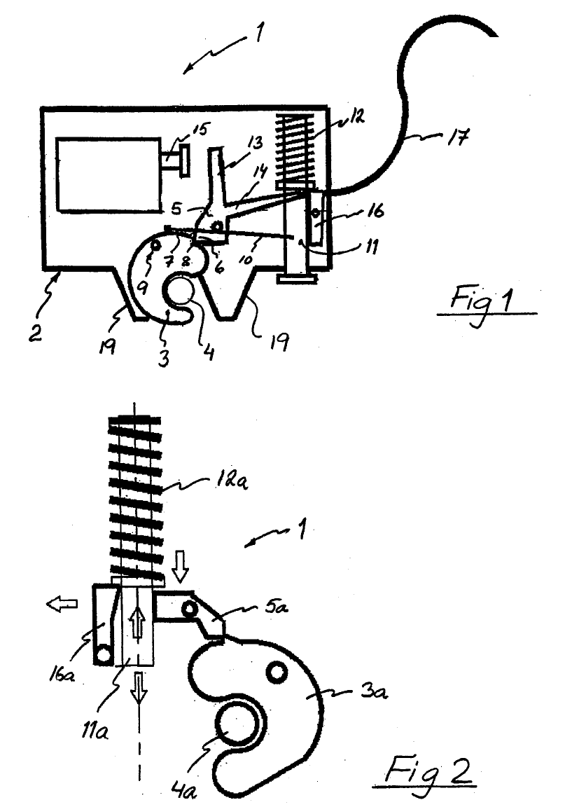

As is shown in FIG. 1, a trunk lid latch device 1 includes a mount 2, on which a pivotable claw 3 is mounted. The claw 3, encircles a striker 4 in a locked condition for the trunk lid (not shown). The latch mechanism 1 in a position as is shown here, may very well be mounted on a lower rear part of a vehicle structure, i.e. a part of the vehicular body. As is also conventional in for instance cars, the device 1 is also, if turned upside down, easy to imagine mounted in a lower rear part of trunk lid. The claw 3 is by use of a spring (not shown) on its pivot shaft biased to unloaded take a position corresponding an opened trunk lid: However, the mount 2 has a primary release pawl 5, which like the claw 3 is biased by a spring (not shown), to here take a position where a pawl portion 6 thereof normally is situated and may slide along a peripheral portion 7 of the claw 3, to eventually, upon closing the trunk lid, engage a notch 8 along the portion 7. In the vicinity of the notch 8, more or less in the middle between the same and a point of pivotation 9 for the claw 3, a pivotable point of fixation for a block bar 10 is situated. The mounting 2 also includes a pop-up bar 11, which is arranged to be able to be positively expelled by a forceful spring 12 at wish. The block bar 10 interacts with the pop-up bar 11 in that the block bar 10, when a trunk lid to which the latch mechanism 1 is applied is open, hinders the activation of the pop-up bar 11 in order to avoid otherwise possible accidents.

The primary release pawl 5, comprise two different actuation means, a first lever 13 and a second lever 14. The first lever 13 is to be actuated by an electromagnetic release piston 16. The other, second lever 14 is to be actuated by the pop-up bar 11 upon actuation thereof. By its design, it will not be affected with regard to possible gin the event of a side-impact accident. Thereby the trunk will not by accident pop-up in such a case, since the pawl is pivotally inertialless around its shaft of pivotation.

The pop-up bar 11 has for its release a secondary release pawl 16, biased toward a position keeping the pop-up bar in a ready to release state, by a spring (not shown) on its shaft. The secondary pawl 16 is for its release connected to a relatively stiff cable 17, having a sling or a loop 18 at its end for gripping purposes. The sling 18 is made fluorescent and is supposed to be led from the latch mechanism 1 through the upholstery of the trunk or trunk lid, depending on its application, to be easy to find and grasp in the event of an entrapment occurring.

According to FIG. 2, a somewhat different embodiment of the sub device 11, 11a, 12, 12a according to the invention is shown. In this case no mounting is shown, however such a mounting is for obvious reasons a necessity here as well according to the above embodiment. A trunk lid latch mechanism, generically between the embodiments denoted 1, has a striker 4a, a claw 3a and a primary release pawl 5a. As is obvious, the primary pawl 5a is independently movable in relation to a secondary release pawl 16a, which against an abutment 20 keeps a pop-up bar 11, 11a, which in turn is biased by a spring 12, 12a, in a resting ready-to-release state. Both the release pawls 5a, 16a are like according to the first embodiment biased by springs (not shown), arranged on the respective shafts around which each pawl is able to pivot upon actuation thereof. The pop-up bars of each the latch mechanisms may comprise an impact spring (not shown) at the outer end of each bar, that minimizes the beating force of the pop-up bar 11 and 11a respectively, when it hits against its counterparts in either the trunk lid or trunk structure, depending upon its mount. In both cases the beating force will generate a loud noise to verify that the lid has been released from its locked and closed position.

Each trunk lid latch device 1 or 1a works in more or less the same fashion. Starting with the device 1 of FIG. 1, the normal service thereof includes the cooperation between the striker 4 and its claw 5, as a counterpart.

When the trunk lid is open the claw 3 is situated in its released state with the block bar 10 in a position penetrating the lower end (in the figure) of the pop-up bar 11. By this penetration by the block bar 10, an unintentional release of the pop-up bar is never possible. One could say that the block 10 gives the sub device 11, 11a; 12, 12a according to the invention a slumbering character by introducing this safety feature.

A normal opening of the trunk lid is affected through actuation of the release piston, which may be either mechanically or electrically triggered or both. The piston 15 acts on the lever 13, to force the primary release pawl 5 out of its notch 8, upon which the claw 3 firstly moves counter clockwise to release from the pawl and secondly turns to move clockwise. Upon turning clockwise, the claw 3 after first having completely pulled the block bar 10 out of the pop-up bar 11 when turning counter clock-wise, the block bar 10 is for further enhancing the security, reinserted, now even further than before.

As is visible in FIG. 1, apart from all parts of the latch device 1 described above, the mount 2 also includes two sturdy jaws 19. As is conventional in latch mechanisms of this kind, these jaws will, if necessary, steer the trunk lid into position for locking when thrusted towards the structure of the trunk lid opening, should the “angle of attack” of the trunk lid be defective in any way.

In the event a person is entrapped inside a vehicle trunk, the cable 17 is due to its fluorescent appearance clearly visibly arranged in the vicinity of the latch mechanism 1. If pulled, the cable 17 in turn pulls the secondary release pawl 16, which frees pop-up bar to an extension necessary to engage with the second lever 14 of the primary pawl 5. Once affected, it pivots the claw 3 some degrees counter-clockwise to an extent necessary to release the same and consequently unlock the trunk lid while in some infinitesimal time unit thereafter also frees the block bar 10 from its engagement with the pop-up bar 11. The pop-up bar 11 is thereafter expelled whereby it forcefully while initially generating the loud noise lifts the trunk lid from the structure of the trunk lid opening, irrespective of a possible snow load (or the like) on top of the lid or not. The trunk lid is thereby opened to an extent that it becomes visible that it is opened and the entrapped person may exit.

In accordance with FIG. 2, the function of the device shown there is in accordance with the following. In a locked condition, the claw 3a encircles its striker 4a. To release the claw 3a from its engagement with the striker 4a, the primary pawl 5a must be pivoted counter clockwise around its point of pivot. When released, the claw 3a no longer keep the primary pawl 5a in a locked position, thus the same releases from the striker 4a.

Should a person get entrapped, like described above, the secondary pawl 16a is instead freed from its engagement with the pop-up bar 11a. Following the release thereof, the same starts to accelerate and in that process it affects the primary pawl 5a in the same fashion as it is positively affected during a normal opening of the trunk lid. Thus the claw 3a almost instantaneously changes position to free the trunk lid, while at the same time the pop-up bar 11a continues to accelerate to push up the trunk lid to an open position, independent of whether it is loaded with for instance snow or else matter.

It should in the context be noted that the active end (maybe “free end” in an expelled condition) of the pop-up bar 11, 11a must not be arranged in contact with its counterpart, the trunk lid (not shown) or the structure of the trunk lid opening, but close thereto to while still generating a loud noise confirming that the lid has been opened as pointed out above, to thereby minimize the size in the impact against the counterpart.

The device as described provides three feedbacks; sound; movement and a visual opening of the trunk lid. It should finally clearly be noted that two criteria must be fulfilled to activate the device according to the invention:
1. The trunk lid must be closed
2. A handle inside the trunk must be pulled.

The invention described in detail above should not in any way be considered delimited by the description of these embodiments but should instead be so considered within the realm of the enclosed claims.

1. A latch device of a lid to a compartment of a vehicle, which prevents unintentional trunk entrapment, the latch device comprising:
a striker in co-operation with a spring biased, pivotally arranged claw, the claw either being held in a locked position, encircling the striker, by a primary releasable pawl wherein the pawl is spring biased and being held in a ready-to-engage state; and
a secondary releasepawl being operable to store energy upon closing the trunk lid, the secondary release pawl being connected to an arrangement situated in the compartment for the release of the secondary pawl, should a person become entrapped inside the compartment, to thereby while releasing the claw from its striker momentarily release the energy stored in the elastic biasing system against either the lid or part of the structure of the vehicle, to thereby positively force the lid to a visibly open position.

2. The device according to claim 1, wherein the elastic biasing system comprises:
a pop-up bar, part of which is encircled by a coil spring acting between a part of a lid or a part of the structure of the vehicle; and
an abutment on the bar, the abutment acting both as such to said spring and as an abutment to said secondary release pawl.

3. The device according to claim 1, wherein the secondary release pawl is spring biased and is actuated by making use of a cable connected to the secondary pawl.

4. The device according to claim 1, further comprising:
a cable being operable as a release mechanism, wherein the cable is connected to the secondary pawl, the cable further comprising an easy to grip shape, being provided with a fluorescent portion to be visible in complete darkness.

5. The device according to claim 1, further comprising:
a normally used actuating system including one of a bowden cable or an electrically powered actuator, wherein one of the Bowden cable or the electrically powered actuator is connected to the primary pawl, where the electrically powered actuator may be remotely controlled.

6. The device according to claim 1, comprising a normally used actuating system including a shape memory alloy element as a part of said pawl, to be locally exposed to heat, such as electrically generated heat, to actuate.

7. The device according to claim 1, wherein the elastic biasing system includes a block bar which automatically blocks said system in an open position for the lid.

8. The device according to claim 1, wherein the elastic biasing system includes a spring biased pop-up bar which in an open position for the trunk lid is transversally blocked by a block bar due to its cooperation with the claw of the lid latch device.
